(19) United States
(12) Patent Application Publication
(10) Pub. No.: US 2002/0080822 A1
(43) Pub. Date: Jun. 27, 2002

(54) Address defined session management over stateless communications channels

(76) Inventors: Michael K. Brown, London (GB); Joshua A. Cooper, London (GB)

Correspondence Address: Robert C. Curfiss, BRACEWELL & PATTERSON, L.L.P., Suite 2900, 711 Louisiana, Houston, TX, 77027-9095, US

(21) Appl. No.: 09/748,049

(22) Filed: Dec. 22, 2000

(51) Int. Cl. H04J 3/24; H04L 12/42

(52) U.S. Cl. 370/475; 370/452

(57) ABSTRACT

Address defined session management permits data interchange across a stateless channel utilizing the existing addressing protocol in a particular communications channel without altering the body of the message itself. By establishing a session identifier, applications and/or users can engage in interactive data communications through any stateless communications channel with any corresponding application that requires interactive communication.

### BACKGROUND OF INVENTION

1. Field of Invention

The subject invention is related to communication systems and processes over private telecommunications networks such as local area networks (LANS) and wide area networks (WANS) and over public networks such as the Internet or world wide web. The invention is specifically directed to an interactive communications environment in stateless channels.

2. Description of the Prior Art

Worldwide, hundreds of millions of short message service (SMS) text messages are sent per month from mobile handsets to other mobile handsets. SMS messages are routed through the public land mobile network (PLMN) through an interconnected network of switching points, enabling most GSM, i.e., “global system for mobile communication,” subscribers to send SMS messages to any other GSM subscriber anywhere in the world.

Each SMS message is addressed using the mobile subscriber's mobile number. The message is sent through a gateway, known as a short message service center (SMSC), which facilitates its delivery onto the PLMN for forward routing to the terminating handset. Each SMS message that is received contains an originating address of the sender as well as the terminating address.

In addition to forwarding the message to the PLMN, the SMSC can interface with computer applications through a communications server, which then interprets data in the body of the message and signals the relevant application appropriately. A popular use of this technique involves informational services that are activated based on receipt of a keyword, known as a “pull” service. For instance, sending a message to a land-based application network server through the SMSC with the keyword WEATHER could signal a computer application to look up a five-day weather forecast and originate a message back to the requestor's address. The keyword WEATHER in the message is critical in determining the route of the message to the appropriate application, in this case a weather forecast application. Because the application network server would not be able to put any further communication with the user into the proper context, the system would be unable to distinguish between a follow-on message regarding the weather or a news request for other information. This lack of context limits these services to simple command and reply because the services do not permit flow-controlled, ordered delivery of messages and replies.

A general technique for overcoming the limitations of stateless communication protocols is session management. Session management permits the linking of messages with an application to establish the history and context of the interaction. Take, for example, the hypertext transfer protocol (HTTP), which is widely used on the Internet today and has revolutionized the way information is communicated. HTTP is a stateless protocol so it requires additional layers of protocol to provide session management and permit anything more than simple command and response.

Web application servers use session management to enable transactions, personalization and contiguous interaction. Session management is implemented through embedding a unique session identifier in a predefined area within the message data itself. The application extracts the session reference from the application data. This technique falls short where the size of the session identifier exceeds or impedes the useful length of the message or it is impractical to insert the session identifier in the message body.

Detailed discussions of the prior art techniques may be found in the following publications: ETS 300 536 (GSM 03.40), “European Digital Cellular Telecommunications System (Phase 2); Technical Realization of the Short Message Service (SMS)—Point to Point (PP)”; and Redl, Siegmund M. “Short Message Service,” GSM and Personal Communications Handbook, Norwood, Mass.: Artech House, 1998.

### SUMMARY OF INVENTION

The subject invention is directed to a method and system for address defined session management and is useful for permitting data interchange across a stateless channel. The session management system of the invention utilizes the existing addressing protocol in a particular communications channel without altering the body of the message itself. By establishing a session identifier, applications and/or users can engage in flow-controlled, ordered data communications through any stateless communications channel with any corresponding application that requires contextual interactive communication. The subject invention is directed to a method and system for address-defined session management permitting data interchange across a stateless channel and utilizes the existing addressing protocol in the particular communications channel without requiring alteration of the body of the message. By establishing a session identifier, the subject invention allows the applications and/or users to engage in flow-controlled, ordered data communications. The invention may be used through any stateless communications channel with any corresponding application that requires an interactive dialogue for communication between user and application, application and application and multiple users via an application.

In the preferred embodiment of the invention, the addressing protocol of the communication channel is used to create a unique session identifier for point-to-point interactive communication. The body of the message is not changed. The session identifier is determined by combining a preselected originating address with the terminating address and is associated with a particular application. By referencing the session information with the session identifier, the subject invention manages interactive messages and their replies.

This permits address defined session management over a stateless channel without modifying the message content. The management method of the invention is equally suited to both mobile originated and computer application originated sessions. The subject invention also permits an end-terminal, such as a mobile telephone or the like, to carry on multiple distinct sessions with various applications by using the relevant session identifier to link the messages together in a contextual manner and associate these messages with their proper application. This will permit greatly enhanced interactive use of stateless channels by providing address defined session management for certain interactive message transmissions.

The application of the subject invention provides for stateless channel communication management of numerous applications in the field of mobile telephony, including but not limited to data transfer, text chat services, instant messaging, ticketing, directory services, travel inquiries and other interactive services. In other media, like the Internet, the subject invention could be used to manage e-mail or fashion anonymous payment processes.

It is, therefore, an object and feature of the subject invention to provide a method for managing flow-controlled, ordered transmission and receipt of application specific messages via a stateless communication channel.

It is another object and feature of the subject invention to mediate message flows among applications in a stateless communication channel.

It is another object and feature of the subject invention to provide a method for managing application message transmission by utilizing the common address protocol of a communications channel without altering the body of the message.

It is an additional object and feature of the subject invention to provide a method for utilizing a preselected origination address and a selected terminating address for identifying a unique session for an application, whereby the unique address combination provides the session identifier for both transmitted and received messages.

It is a further object and feature of the subject invention to provide a method for identifying a unique application session by embedding a preselected originating address and a selected termination address in an application message.

It is a further object and feature of the subject invention to provide a method for the selection and management of the originating address to define and manage sessions.

Other objects and features of the invention will be readily apparent from the accompanying drawings and description.

### BRIEF DESCRIPTION OF THE DRAWINGS

FIG. 1 is a diagram of the processes of the subject invention as applied to SMS message transmission and reply through the public land mobile network.

FIG. 2 is a flow diagram illustrating the decision processes for the subject invention.

### DESCRIPTION OF THE PREFERRED EMBODIMENT

The subject invention is directed to a method and system for address defined session management permitting data interchange across a stateless channel. The subject invention utilizes the existing addressing protocol in the particular communications channel and does not alter the body of the message itself. By establishing a session identifier, the subject invention allows the applications and/or users to engage in flow-controlled, ordered data communications. The invention may be used through any stateless communications channel with any corresponding application that requires interactive communication. The invention contemplates and supports communication between user and application, application and application and multiple users via an application. The invention supports application-to-application communication via the stateless communication channel.

The subject invention is a process by which a unique session identifier is created for point-to-point interactive communication by utilizing the address information as defined by the messaging protocol. Typically, communications through stateless channels include addressing information, which usually consists of the originating address and the terminating address. The subject invention provides session management utilizing a combination of the originating and terminating addresses and an application identifier. It accomplishes this by establishing a pool of unique addresses. One originating address is selected from this pool of addresses for each interactive session. The combination of the originating and terminating addresses determines a unique session identifier. This session identifier makes it possible to string bidirectional messages together and direct messages between any combination of users and applications. In this way, the subject invention permits multiple applications to share a channel without state as if the channel were in state and allows for session management to exist.

Specifically, the invention permits independent messages to be linked to one another and associated with the relevant application through the combination of the originating and terminating addresses embedded in the message. This permits multiple applications to send and receive messages to a specific terminal equipment unit and the terminal equipment unit to receive and respond over a common channel without confounding the messages of various applications. The relevant messages are distinguished from other non-relevant messages by identifying the unique originating address/terminating address combination and referencing the appropriate session data, including the relevant application. Likewise, the application can reference the session through the session identifier.

For instance, the subject invention would permit the user of a mobile phone by employing text messaging, which uses a stateless channel, to engage in a text chat service while simultaneously booking theater tickets. The subject invention uses existing parameters in the messaging protocol to link messages and responses to each other as well as to the appropriate application. Thus, the application network server could receive two SMS messages from the user's mobile telephone and identify the corresponding context in which the SMS messages were sent.

The subject invention has a variety of uses, depending on the particular channel and applications. For the purposes of illustration, we will describe the use of the subject invention in the context of mobile SMS messaging. The messaging protocol defines the address space. In the case of SMS messaging, the addresses most likely are mobile telephone numbers.

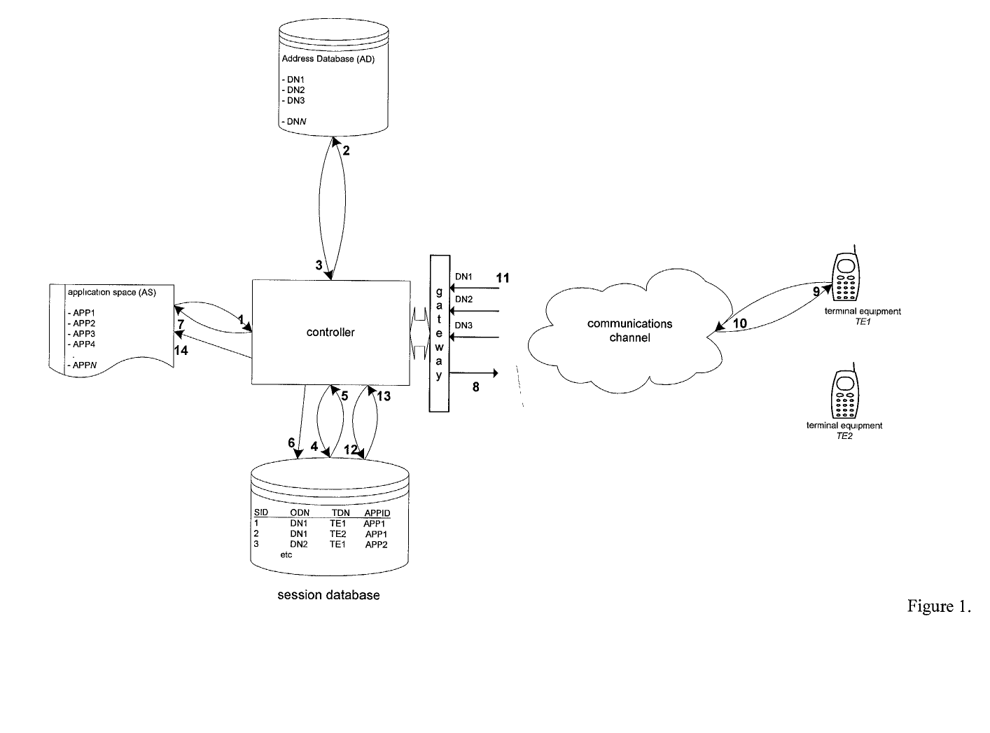

With specific reference to FIG. 1, the application space AS includes a plurality of applications APP1-APPn. The address database AD includes a plurality of addresses or directory numbers DN1-DNn. The session database SD is used for identifying, creating, managing, and ultimately destroying a session, as will be explained. These databases and the application space AS communicate with the processor or controller C. The controller then communicates via the gateway to the communications channel, whereby the message is transmitted through the communications channel to and from a variety of terminal equipment such as, by way of example the terminal mobile telephone TE1.

The specific sequence as contemplated in the disclosed embodiment is as follows: As indicated by path 1, an application APP requests the controller C to set up a new dialogue with an end-user at a terminating directory number (TDN). As indicated by path 2 and 3, the controller C queries a list of all available number to serve as the originating directory number (ODN) in the ODN-TDN combination from the address pool and this information is returned to the controller. In paths 4 and 5, the controller then queries all of the relevant existing session information for the specified TDN and requests details from the database. After selecting a unique ODN-TDN-session identifier combination via a selection algorithm (see below), the controller C creates a new entry into the session database with an assigned session identifier (SID) and application identifier (APPID), see path 6. The controller then sends the newly created SID to the application for further reference to this dialogue, see path 7. The controller C then sends the message with the assigned ODN and TDN via the gateway as outlined in path 8. The message traverses the communications channel and is received by the terminal equipment, TE1, see path 9.

The end user replies to the SMS message on the terminal equipment. It is likely that this would be accomplished utilizing the reply menu in a user's mobile telephone. The reply message is then formatted using the original messages ODN and the mobile telephone of the end-user. The reply message is received via reply paths 10 and 11 and ultimately through the gateway to the controller C. The controller extracts the ODN-TDN combination from the received message. The controller C then retrieves the SID and APPID from the session database (SD) by utilizing the ODN-TDN unique key (see path 12 and 13). The controller then forwards the message data along with the SID to the relevant application in the application space AS, see path 14. In the event that the application wishes to continue the dialogue, the APP will transmit both the message body and the SID to the controller. The controller will then find the SID in the SD to obtain the ODN-TDN for the message. Thereafter, the message is encoded as detailed above in path 8 and process continues through to path 14.

It should be noted that the flow-controlled, ordered communications supported by the present invention will support not only application originated communications to a termination address, but also termination originated communications to a specific application, as well as application-to-application communications. Once a session has been identified and managed with respect to an application, the process functions whether the communication begins with the application or with the termination destination. With specific reference to FIG. 1, it will be noted that the same communication paths are utilized but in reverse sequence. When the communication is between applications, the left-side of FIG. 1 (relative to the gateway) is simply duplicated as a mirror-image system on the right side of the gateway. Where multiple termination destinations communicate to the originating application via another application, the right-side of FIG. 1 (relative to the gateway) is in communication with the intermediate application in accordance with the teachings of the invention.

There are at least two selection algorithms to select the matching ODN-TDN unique key. The static selection algorithm uses the same ODN throughout the life of the session. The dynamic selection algorithm changes the ODN throughout the life the session. An application may choose to use either or a combination of the two. Factors determining the algorithm include, but are not limited to: the need to enforce linear dialogues, the desirability to permit forking of dialogues, and ensuring message sequencing. By way of example, the static algorithm would be selected when it is desired to replicate a dialogue with a full history, whereas a dynamic dialogue may be useful with the history is not important or, more important, when preserving the message history is important.

The invention supports both the static selection algorithm and the dynamic selection algorithm or a combination of the two, depending on the requirements of the application. Specifically, an application will indicate whether it requires a static or dynamic selection algorithm or a combination when it contacts the controller with the message and terminating address. In a dynamic algorithm, the session over its life will include more than one originating address. Thus, each back and forth dialogue will correspond to different ODN. In this way, it is possible to engage in forked decision making or revisit in sequence prior communications. A static selection algorithm will provide only one ODN for the entire session.

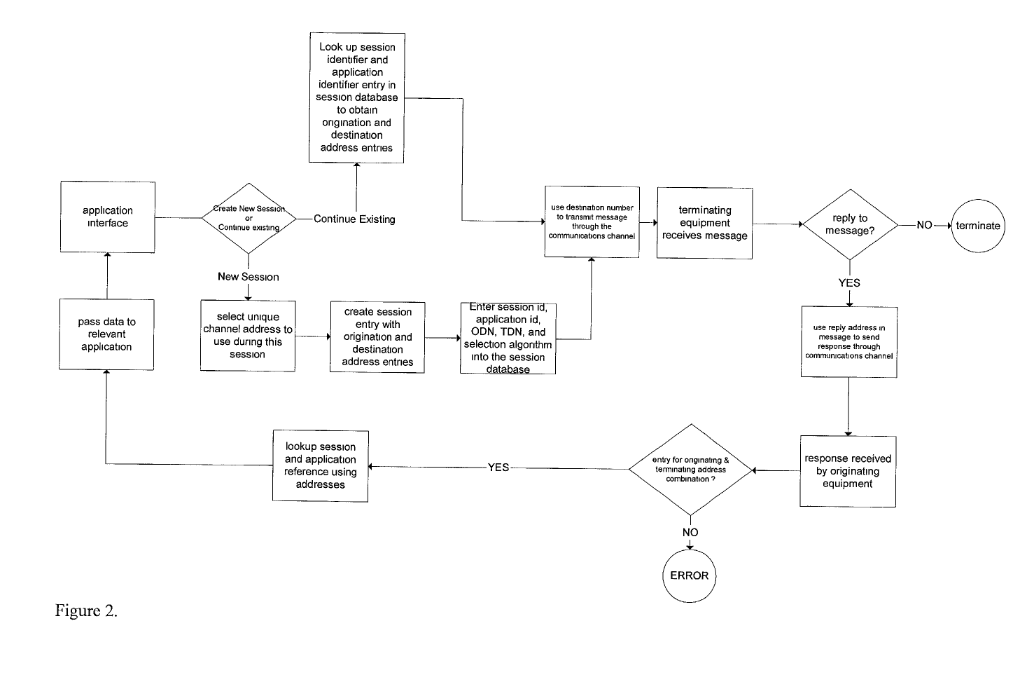

The process for stateless session management is illustrated in the flow chart of FIG. 2. As shown, the application initiates the process. It is next determined whether the application is initiating a new session or continuing an existing session. If it is determined to continue an existing session, then the session identifier is used to obtain the originating and terminating address entries and associated session data in the session database. The message is transmitted through the communications channel to the terminating number and the terminating equipment receives the message. The terminating equipment may then elect to reply to the message or to not reply. If NO, the communication is terminated. If YES, the reply address embedded in the message is used to send the reply via the same communications channel and the reply message is sent to the originating equipment. The originating and terminating addresses are reviewed and if they correspond to a session identifier, the reply message is sent to the relevant application interface by looking up the corresponding application identifier in the session database. Specifically, the originating address and the terminating address collectively determine the relevant terminating application for the reply information.

In the event a session does not exist when the application interface initiates a transmission, a new session is created by selecting an available originating address to be used in combination with the terminating address to define a unique session identifier. It may be that the originating address is already in use with another terminating address. It only matters that the combination of the originating and the terminating addresses be unique. The session identifier, application identifier, originating address, terminating address and selection algorithm are entered into the session database prior to using the terminating address to transmit the message via the communications channel.

The application of the subject invention described above is just one of numerous applications in the field of mobile telephony. Other uses include text chat services, instant messaging, ticketing, directory services, travel inquiries and other interactive services. In other media, like the Internet, the subject invention could be used to manage e-mail or fashion anonymous payment processes. It will be understood that any of the currently available or any future stateless communication channel systems can be used in connection with the subject invention in order to support address defined session management permitting data interchange of flow-controlled, ordered communication. By way of example, currently available stateless communication channels include, but are not limited to: wireless telephonic systems; global systems for mobility (GSM's); public switch telephonic networks (PSTN's); public land mobile networks (PLMN's); personal area networks; pager networks; local area networks (LAN's); wide area networks (WAN's); and the Internet.

While certain features and embodiments of the invention have been described in detail herein, it should be understood that the invention includes all modifications and enhancements within the scope and spirit of the following claims.

1. A method for managing a transmission session over a stateless communication channel, comprising the steps of:
a. permitting an application to originate a message to a specific terminating address;
b. assigning an originating address to the application from a pool of originating addresses;
c. including the terminating address and the originating address in the application message for defining a managed transmission message; and
d. transmitting the managed transmission message.

2. The method of claim 1, wherein the originating address is randomly assigned to the application.

3. The method of claim one, wherein the originating address is dynamically assigned and changes throughout the session.

4. The method of claim 1, wherein the originating address is static throughout the session.

5. The method of claim 1, further comprising the step of replying to the managed transmission message from the transmission terminal by using the included terminating address and originating address for identifying the message originator and specifically identifying the reply transmitter to the originator.

6. The method of claim 1, wherein the application is selected from a plurality of defined applications.

7. The method of claim 6, wherein the plurality of defined applications is provided in an accessible database.

8. The method of claim 1, wherein the application is selected from a plurality of defined applications and wherein the selection of the application initiates the selection of the originating address.

9. The method of claim 8, wherein the plurality of defined applications is provided in an accessible database.

10. The method of claim 8, wherein the originating address is embedded in the selected application.

11. The method of claim 8, wherein the originating address is selected from a plurality of defined originating addresses.

12. The method of claim 11, wherein the plurality of defined originating address is provided in an accessible database.

13. The method of claim 11, wherein the selected originating address is randomly selected and associated with a selected application.

14. The method of claim 8, wherein the originating address is embedded in the selected application message for defining a managed transmission message.

15. The method of claim 1, wherein a session is defined by the application identification and a terminating address.

16. The method of claim 15, wherein the session is further defined by the assignment of an originating address.

17. The method of claim 6, wherein a reply message is transmitted to a selected application by comparing the originating address and the terminating address in the application message.

18. The method of claim 1, including the step of transmitting the managed transmission message via a stateless communication channel.

19. The method of claim 1, including the step of transmitting the managed transmission message via a wireless telephonic system.

20. The method of claim 19, wherein the telephonic system comprises a global system for mobility (GSM).

21. The method of claim 19, wherein the telephonic system comprises a public switch telephonic network (PSTN).

22. The method of claim 19, wherein the telephonic system comprises a public land mobile network (PLMN).

23. The method of claim 1, including the step of transmitting the managed transmission message via a personal area network.

24. The method of claim 1, including the step of transmitting the managed transmission system via a pager network.

25. The method of claim 1, including the step of transmitting the managed transmission message via a local area network.

26. The method of claim 1, including the step of transmitting the managed message via a wide area network.

27. The method of claim 1, including the step of transmitting the managed message via the Internet.

28. The method of claim 1, further including a mobile telephone as the transmission terminal.

29. The method of claim 1, further including the step of assigning a session identifier associated with the managed transmission message and unique to the selected terminating address and application whereby a reply message may be matched to a managed transmission message.

30. The method of claim 29, further including the originating address as a segment of the session identifier.

31. The method of claim 30, further including the step of routing a matched reply message to the application.

32. The method of claim 1, wherein the transmitting step includes initially transmitting the managed transmission message from an originating application base to a terminating terminal designated by the terminating address.

33. The method of claim 1, wherein the transmitting step includes initially transmitting the managed transmission message from a terminating terminal to an originating application base.

34. The method of claim 32, wherein the terminating terminal is another originating application destination.

35. The application of claim 33, wherein the terminating terminal is another originating application destination.

36. The method of claim 29, wherein the application is selected from a plurality of defined applications and wherein the selection of the application initiates the selection of the originating address, and wherein the origination address remains static throughout a session.

37. The method of claim 36, wherein the selection of the originating address is from the plurality of originating addresses is random.

38. The method of claim 29, wherein the application is selected from a plurality of defined applications and wherein the selection of the application initiates the selection of the originating address, and wherein the origination address is dynamic throughout a session.

39. The method of claim 38, wherein the selection of the originating address is from the plurality of originating addresses is random.

40. The method of claim 1, wherein the application and the user are only identifiable through an anonymous proxy.

41. The method of claim 40, wherein the application is an anonymous payment system.
